(19) United States
(12) Patent Application Publication
(10) Pub. No.: US 2015/0002988 A1
(43) Pub. Date: Jan. 1, 2015

(54) STORAGE CELL

(71) Applicant: SUMITOMO HEAVY INDUSTRIES, LTD., Tokyo (JP)

(72) Inventor: Takuya ISHIZAKA, Yokosuka-shi (JP)

(73) Assignee: SUMITOMO HEAVY INDUSTRIES, LTD., Tokyo (JP)

(21) Appl. No.: 14/288,571

(22) Filed: May 28, 2014

(30) Foreign Application Priority Data
Jun. 26, 2013 (JP) 2013-133927

(51) Int. Cl. H01G 11/06; H01G 11/60

(52) U.S. Cl. CPC H01G 11/06; H01G 11/60
USPC 361/502

(57) ABSTRACT

A storage cell includes a positive electrode that includes a positive electrode current collector and a positive electrode active material layer which is formed on a surface of the positive electrode current collector and contains activated carbon, a negative electrode that includes a negative electrode current collector and a negative electrode active material layer which is formed on a surface of the negative electrode current collector and contains lithium titanate, and a separator that is disposed between the positive electrode active material layer and the negative electrode active material layer and is impregnated with an electrolytic solution which has lithium ion conductivity, in which a charge and discharge capacity through lithium ion occlusion is 16 mAh to 152 mAh per gram of the lithium titanate.

### INCORPORATION BY REFERENCE

Priority is claimed to Japanese Patent Application No. 2013-133927, filed Jun. 26, 2013, the entire content of which is incorporated herein by reference.

### BACKGROUND

1. Technical Field

The present invention relates to a storage cell. More particularly, the present invention relates to a storage cell that combines storage by an electric double layer and storage through lithium ion occlusion and discharge.

2. Description of the Related Art

In the related art, the development of secondary batteries such as lithium ion batteries and electrochemical capacitors such as electric double layer capacitors as storage devices mounted on hybrid vehicles and fuel cell vehicles has been in progress. In more recent years, hybrid capacitors that store energy through an oxidation reduction reaction in a positive electrode or a negative electrode have been proposed, in addition to electric double layers, to improve the energy density of the capacitors. Lithium titanate, which has a higher lithium occlusion discharge potential than carbon-based materials, has attracted attention as the material used in the negative electrode of this type of hybrid capacitor.

### SUMMARY

According to an embodiment of the present invention, there is provided a storage cell. The storage cell includes a positive electrode that includes a positive electrode current collector and a positive electrode active material layer which is formed on a surface of the positive electrode current collector and contains activated carbon, a negative electrode that includes a negative electrode current collector and a negative electrode active material layer which is formed on a surface of the negative electrode current collector and contains lithium titanate, and a separator that is disposed between the positive electrode active material layer and the negative electrode active material layer and is impregnated with an electrolytic solution which has lithium ion conductivity, in which a charge and discharge capacity by lithium ion occlusion is 16 mAh to 152 mAh per gram of the lithium titanate.

### BRIEF DESCRIPTION OF THE DRAWINGS

FIG. 1 is a perspective cross-sectional view showing an example of a specific structure of a storage cell according to an embodiment of the present invention.

FIG. 2 is a partially enlarged cross-sectional view of an electrode body.

FIG. 3 is a graph showing a theoretical charge discharge curve with respect to the storage cell.

FIG. 4 is a graph in which a positive electrode potential of the storage cell according to the embodiment of the present invention and a positive electrode potential of a storage cell according to a comparative example in initial states are superimposed on the charge discharge curve.

FIG. 5 is a graph showing a time-dependent change in capacity maintenance rate.

FIG. 6 is a graph showing a time-dependent change in internal resistance maintenance.

### DETAILED DESCRIPTION

The present inventors examined hybrid capacitors (storage cells) in which lithium titanate is used in negative electrodes to find out that the hybrid capacitors are subjected to a severe time-dependent deterioration depending on a ratio between the mass of the lithium titanate and the mass of a positive electrode material.

It is desirable to provide a technique that is capable of suppressing a time-dependent deterioration of a storage cell using lithium titanate in a negative electrode.

In the storage cell according to the embodiment, a mass ratio between the activated carbon and the lithium titanate may be 1.5:1 to 7.5:1. In addition, a content of the lithium titanate of the negative electrode active material layer may be at least 80 percentage by mass. In addition, the electrolytic solution may include an organic solvent selected from a group consisting of propylene carbonate, ethyl carbonate, diethyl carbonate, and dimethyl carbonate.

Any appropriate combination of the above-described elements is included within the scope of the present invention to be protected by the application of the present invention.

According to the embodiment of the present invention, a longer life can be ensured for a storage cell using activated carbon as a positive electrode active material and lithium titanate as a negative electrode active material.

Hereinafter, an embodiment of the present invention will be described with reference to the accompanying drawings. The same reference numerals are attached to the same elements throughout the drawings, and description thereof will be omitted as appropriate.

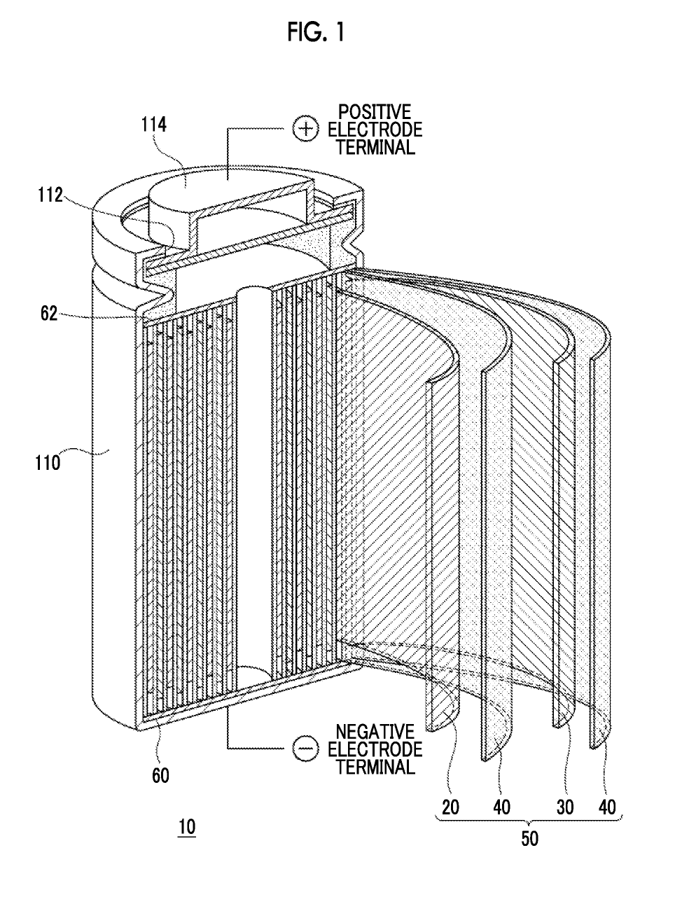

FIG. 1 is a perspective cross-sectional view showing an example of a specific structure of a storage cell according to the embodiment of the present invention. A storage cell 10 according to this embodiment can be a cylindrical hybrid capacitor in which a voltage can be applied between a positive electrode and a negative electrode to form a charge layer in the positive electrode and a capacity of the negative electrode can be represented by a capacitive component resulting from an occlusion and a discharge of lithium (Li) ion, which is an electrode reaction material. As shown in FIG. 1, an electrode body 50, in which a pair of a strip-shaped positive electrode 20 and a strip-shaped negative electrode 30 can be laminated or wound via separators 40, can be accommodated in a hollow columnar-shaped accommodating can 110. The accommodating can 110 can be formed, for example, of nickel-plated iron, and can function as a negative electrode terminal. One cylindrical axial end portion of the accommodating can 110 can be sealed, and the accommodating can 110 can have an opening 112 in the other end portion.

Insulators 60 and 62 can be respectively arranged on both side surfaces of the electrode body 50 in an axial direction of the accommodating can 110. A sealing plate 114, which can function as a positive electrode terminal, can be arranged at the opening 112. A gasket 116 can be interposed between the accommodating can 110 and the sealing plate 114, and thus the accommodating can 110 and the sealing plate 114 can be insulated. The positive electrode 20 and the sealing plate 114 can be electrically connected by a positive electrode lead (not shown). In addition, the negative electrode 30 and the accommodating can 110 can be electrically connected by a negative electrode lead (not shown).

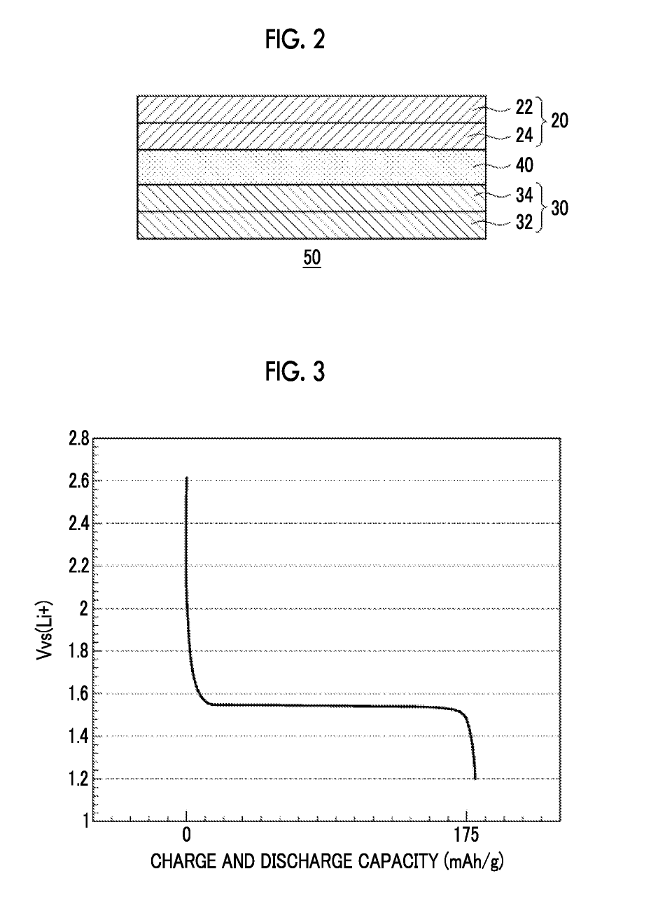

FIG. 2 is a partially enlarged cross-sectional view of the electrode body 50. Hereinafter, configurations of the positive electrode 20, the negative electrode 30, and the separators 40 of the storage cell 10 will be described with reference to FIG. 2.

### Positive Electrode

The positive electrode 20 can have a positive electrode current collector 22 and a positive electrode active material layer 24. The positive electrode current collector 22 can be formed, for example, of a metal foil of aluminum or the like. The thickness of the positive electrode current collector 22 is not particularly limited and can be, for example, 10 μm to 50 μm. The positive electrode active material layer 24 can be formed in contact with a surface of the positive electrode current collector 22. The positive electrode active material layer 24 can contain activated carbon as a material forming the charge layer through a physical adsorption of an anion. The capacity of the activated carbon is not particularly limited and can be, for example, 10 F/g to 60 F/g. The thickness of the positive electrode active material layer 24 is not particularly limited and can be, for example, 50 μm to 300 μm.

### Negative Electrode

The negative electrode 30 can have a negative electrode current collector 32 and a negative electrode active material layer 34. The negative electrode current collector 32 can be formed, for example, of a metal foil of copper or the like. The thickness of the negative electrode current collector 32 is not particularly limited and can be, for example, 10 μm to 50 μm. The negative electrode active material layer 34 can be formed in contact with a surface of the negative electrode current collector 32. The negative electrode active material layer 34 can contain lithium titanate as a negative electrode active material capable of occluding and discharging a lithium ion contributing to an electrode reaction. The lithium titanate used in this embodiment can have a spinel structure and can be represented by the general formula Li₄Ti₅O₁₂. The thickness of the negative electrode active material layer 34 is not particularly limited and can be, for example, 5 μm to 50 μm.

The storage cell 10 according to this embodiment can be designed such that the charge and discharge capacity by the lithium ion occlusion is 16 mAh to 152 mAh per gram of the lithium titanate. This range can correspond to a plateau region of the theoretical charge discharge curve with respect to the storage cell 10 shown in FIG. 3, where the potential is substantially constant at 1.55 V regardless of the capacity. The charge and discharge capacity within the above-described range can be realized when, for example, the mass ratio between the activated carbon contained in the positive electrode active material layer 24 and the lithium titanate contained in the negative electrode active material layer 34 is 1.5:1 to 7.5:1 and the content of the lithium titanate is larger than the content of the activated carbon.

The negative electrode active material layer 34 may contain a conductive material such as carbon black in addition to the lithium titanate. In this manner, the conductivity of the negative electrode active material layer 34 can be increased. However, in this case, it is preferable that the content of the lithium titanate in the negative electrode active material layer 34 be at least 80 percentage by mass. In a case where the content of the lithium titanate is below 80 percentage by mass, that is, even when the content of the conductive material exceeds 20 percentage by mass, any further conductivity improvement by an addition of the conductive material cannot be expected.

### Separator and Electrolyte

The separator 40 can be interposed between the positive electrode active material layer 24 and the negative electrode active material layer 34 to prevent a short circuit resulting from a contact between the positive electrode 20 and the negative electrode 30, and can have the function of transferring the lithium ion between the positive electrode active material layer 24 and the negative electrode active material layer 34. The material of the separator 40 is not particularly limited insofar as the material can be impregnated with an electrolytic solution (described later), and a known material can be used for the separator 40. Examples of the material of the separator 40 can include a porous membrane formed of an insulating resin such as polytetrafluoroethylene, polyethylene, and polypropylene and a cellulose-based porous membrane.

The electrolytic solution with which the separator 40 is impregnated can be a liquid in which lithium salt such as LiPF₆ and LiBF₄ is dissolved in an organic solvent. Examples of the organic solvent can include propylene carbonate, ethyl carbonate, diethyl carbonate, and dimethyl carbonate. It is preferable that the propylene carbonate, which has a relatively high decomposition voltage, be the organic solvent. 0.5 mol/L to 3 mol/L, preferably 1.0 mol/L to 1.5 mol/L of the above-described lithium salt can be dissolved with respect to the organic solvent.

According to the electrolysis cell 10 described above, a time-dependent degradation can be suppressed or durability can be improved when a ratio P/N between the mass N of the lithium titanate used as the negative electrode active material and the mass P of the activated carbon used as the positive electrode active material is 1.5 to 7.5 and the charge and discharge capacity by the lithium ion occlusion is 16 mAh to 152 mAh per gram of the lithium titanate.

### EMBODIMENTS

Hereinafter, preferred embodiments of the present invention will be described. These embodiments are examples for an appropriate description of the present invention and the present invention is not limited thereto.

### Embodiments

The storage cell according to the embodiment can be produced through the following procedure.

### Production of Positive Electrode

31 g of a mixture of acetylene black as a conductive additive and styrene butadiene rubber and carboxymethyl cellulose as binders is mixed, in addition to 70 g of pure water, with the activated carbon of a capacity of 20 F/g as the positive electrode active material to prepare slurry. The slurry is applied to a current collector, which is formed of an aluminum foil with a thickness of 30 μm, at a coating thickness of 100 μm, is dried, and then is pressed to produce the positive electrode with a density of 0.5 g/cm³ and a mass of the positive electrode active material layer of 50 g per 1 m² area.

### Production of Negative Electrode

30 g of the lithium titanate (Li₄Ti₅O₁₂) powder as the negative electrode active material having the spinel structure, 1.8 g of the acetylene black as the conductive additive, and 2.6 g of a mixture of the styrene butadiene rubber and the carboxymethyl cellulose as the binders are mixed in addition to 62 g of pure water to prepare slurry. The slurry is applied to a current collector, which is formed of a copper foil with a thickness of 35 μm, is dried, and then is pressed to produce the negative electrode with a density of 1.8 g/cm³ and a mass of the negative electrode layer of 17 g per 1 m² area.

### Production of Electrode Body

LiPF₆ is dissolved, at a concentration of 1 mol/L, in a mixed organic solvent (decomposition voltage 4.25 (vsLi)) in which the mass ratio between ethylene carbonate and dimethyl carbonate is 1:1 to prepare the electrolytic solution. The separator formed of a cellulose-based porous film with a thickness of 35 μm is impregnated with the electrolytic solution to produce two sets of the separators impregnated with the electrolytic solution. The above-described positive electrode, one of the above-described separators, the above-described negative electrode, and the other one of the above-described separators are laminated in this order, and then are wound into a vortex shape to produce the cylindrical electrode body. The resultant electrode body is accommodated in the accommodating can formed of aluminum to be vacuum-dried for 24 hours at 80° C.

The capacity of the negative electrode of the storage cell according to the embodiment produced through the above-described procedure is 16.7 mAh/g.

### Comparative Example

31 g of a mixture of acetylene black as a conductive additive and styrene butadiene rubber and carboxymethyl cellulose as binders is mixed, in addition to 70 g of pure water, with the activated carbon of a capacity of 20 F/g as the positive electrode active material to prepare slurry. The slurry is applied to a current collector, which is formed of an aluminum foil with a thickness of 30 μm, at a coating thickness of 14 μm, is dried, and then is pressed to produce the positive electrode with a density of 0.5 g/cm³ and a mass of the positive electrode active material layer of 7 g per 1 m² area. The capacity of the negative electrode of the storage cell according to the comparative example is 6.7 mAh/g.

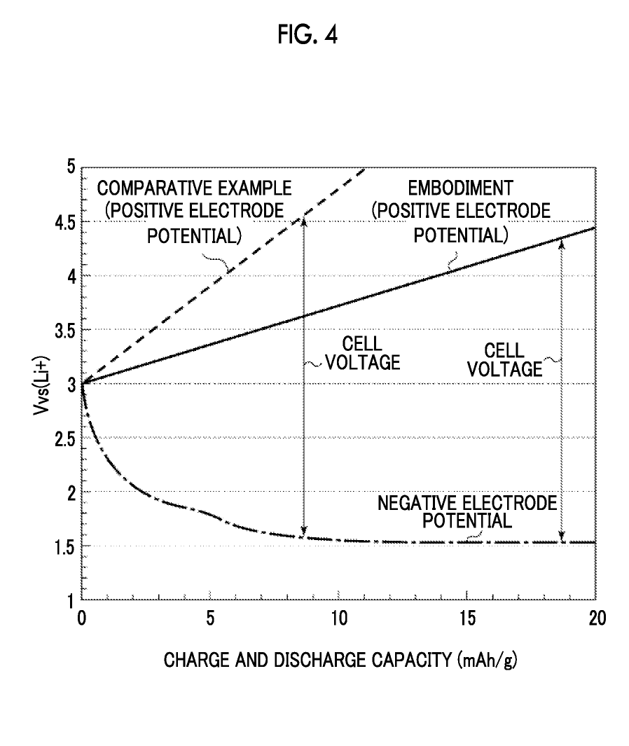

FIG. 4 is a graph in which a positive electrode potential of the storage cell according to the embodiment of the present invention and a positive electrode potential of the storage cell according to the comparative example in initial states are superimposed on the charge discharge curve. As shown in FIG. 4, the storage cell according to the embodiment can have a lower cell voltage than the storage cell according to the comparative example, and thus the decomposition of the organic solvent used in the electrolytic solution can be suppressed.

### Durability Evaluation

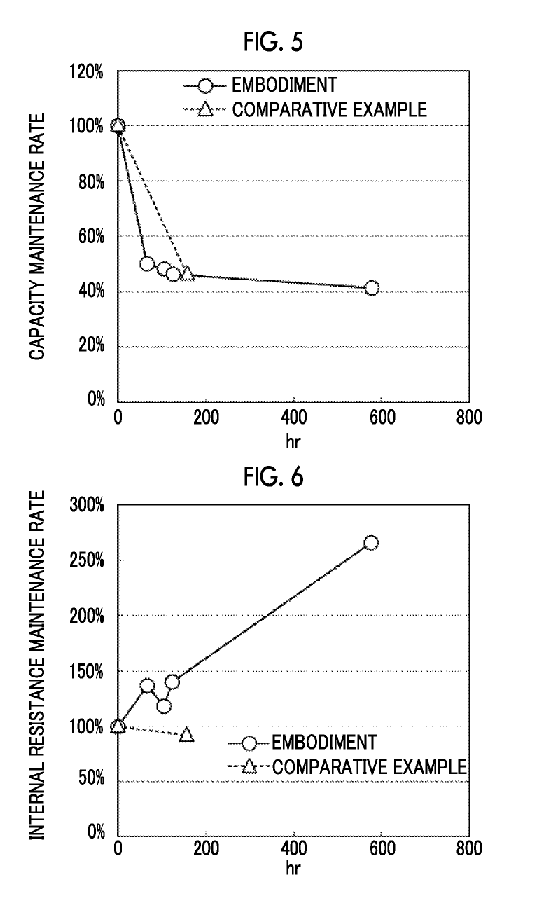

Accelerated tests were implemented on the respective storage cells according to the embodiment and the comparative example at a charging voltage of 2.7 V and an environmental temperature of 70° C., and charge and discharge cycles were implemented after a lapse of a predetermined time to measure capacity maintenance rates and internal resistance maintenance rates. FIGS. 5 and 6 are graphs respectively showing time-dependent changes in capacity maintenance rate and internal resistance maintenance rate. The storage cell according to the comparative example allowed the measurement until a lapse of 180 hours, but the subsequent internal resistance increased not to be measurable, the charge and discharge were impossible, and the measurement of the capacity maintenance rate was impossible. In contrast, the internal resistance maintenance rate of the storage cell according to the embodiment was suppressed to 250% after a lapse of 600 hours to be within a measurable range. In addition, the capacity maintenance rate of the storage cell according to the embodiment after a lapse of 600 hours was substantially equal to that after a lapse of 160 hours, and a significant improvement in durability was confirmed.

The present invention is not limited to the embodiment described above, and modifications such as design change can be added thereto based on the knowledge of those skilled in the art. Embodiments to which such modifications are added are also included within the scope of the present invention.

For example, although the cylindrical hybrid capacitor has been used as an example of the aspect of the storage cell according to the above-described embodiment, the present invention is not limited thereto and a square type hybrid capacitor and a coin type hybrid capacitor, where an electrode body is wound in a flat shape, may be used.

It should be understood that the invention is not limited to the above-described embodiment, but may be modified into various forms on the basis of the spirit of the invention. Additionally, the modifications are included in the scope of the invention.

What is claimed is:

1. A storage cell comprising:
a positive electrode that includes a positive electrode current collector and a positive electrode active material layer which is formed on a surface of the positive electrode current collector and contains activated carbon;
a negative electrode that includes a negative electrode current collector and a negative electrode active material layer which is formed on a surface of the negative electrode current collector and contains lithium titanate; and
a separator that is disposed between the positive electrode active material layer and the negative electrode active material layer and is impregnated with an electrolytic solution which has lithium ion conductivity,
wherein a charge and discharge capacity through lithium ion occlusion is 16 mAh to 152 mAh per gram of the lithium titanate .

2. The storage cell according to claim 1,
wherein amass ratio between the activated carbon and the lithium titanate is 1.5:1 to 7.5:1.

3. The storage cell according to claim 1, wherein a content of the lithium titanate of the negative electrode active material layer is at least 80 percentage by mass.

4. The storage cell according to claim 1,
wherein the electrolytic solution includes an organic solvent selected from a group consisting of propylene carbonate, ethyl carbonate, diethyl carbonate, and dimethyl carbonate.
